(19) United States
(12) Patent Application Publication
(10) Pub. No.: US 2013/0043112 A1
(43) Pub. Date: Feb. 21, 2013

(54) Extended Light Switch Glow Cap

(71) Applicants: Joseph Frank Rubio, El Paso, TX (US); Leticia Primero, El Paso, TX (US)

(72) Inventors: Joseph Frank Rubio, El Paso, TX (US); Leticia Primero, El Paso, TX (US)

(73) Assignee: LEFRAN, LLC, El Paso, TX (US)

(21) Appl. No.: 13/396,432

(22) Filed: Feb. 14, 2012

Related U.S. Application Data
(60) Provisional application No. 61/463,135, filed on Feb. 14, 2011.
(60) Provisional application No. 61/546,454, filed on Oct. 12, 2011.

(51) Int. Cl. H01H 9/00; G09F 3/00; B23P 11/00

(52) U.S. Cl. 200/331; 29/428; 40/299.01

(57) ABSTRACT

An embodiment of the present invention provides for a cap that slips on the toggle component of a switch comprising a hollow body with a first end and a second end; said first end comprising an opening to slip said cap onto said toggle component; said second end being closed; and glow in the dark pigmentation in said body and a method of extending the size and increasing the visibility of the toggle component of a switch.

### CROSS-REFERENCE TO RELATED APPLICATIONS

This application claims priority to and the benefit of U.S. Provisional Patent Application Ser. No. 61/463,135 entitled X-Tended Power Glow Switch Cap—Is Designed to Help You Quickly and Safely Find Light Switches in the Dark—Fits on Light Switches Conforms to Switch Post, filed on Feb. 14, 2011 and to U.S. Provisional Patent Application Ser. No. 61/546,454 entitled Extended Light Switch Glow Cap, filed on Oct. 12, 2011 and the specification and claims thereof are incorporated herein by reference.

### BACKGROUND OF THE INVENTION

### Field of the Invention Technical Field

One aspect of the present invention relates to a cap that extends the length, and improves the visibility of the toggle component in a common toggle light switch.

The toggle light switch was invented in 1916 by William J. Newton and Morris Goldberg. Although this type of light switch is still ubiquitously used today, it has the disadvantage that its small size makes it hard to find in the dark. An aspect of an embodiment of the present invention solves this challenge by providing a cap that easily slips on the toggle component of the switch, extending its reach, and facilitating its maneuverability. Additionally, the cap glows for increased visibility in the dark.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side perspective image of a common toggle light switch;

FIG. 2 is a side perspective image of a common toggle light switch with an embodiment of the present invention disposed thereon;

FIG. 3 shows an embodiment of the present invention comprising a circular cylindrical body and a round end;

FIG. 4 shows two additional embodiments of the present invention comprising a rectangular cylindrical body with flat and round ends;

FIG. 5 is a perspective side view of an embodiment of the present invention;

FIG. 6 is a side view of the embodiment of FIG. 5;

FIG. 7 is a top view of the embodiment of FIG. 5;

FIG. 8 is a bottom view of the embodiment of FIG. 5; and

FIG. 9 is a perspective side view of the embodiment of FIG. 5 disposed on a common toggle light switch.

### SUMMARY OF THE INVENTION

Disclosed is a cap that slips on the toggle component of a switch, comprising a hollow body with a first end and a second end, the said first end comprising an opening to slip the cap onto the toggle component, the second end being closed, and glow in the dark pigmentation in the body. In one embodiment the body of the cap is an elongated cylinder. In one embodiment the first end is sized to slip on the toggle component of a switch. In one embodiment the second end is round in shape. In another embodiment the second end is flat in shape. The cap can comprise a textured finish on the outer surface of its body. Also, the cap can comprise printed images on the outer surface of its body.

Also disclosed is a method of extending the size and increasing the visibility of the toggle component of a switch. This method comprises providing a hollow cylindrical cap that glows in the dark, and slipping the cap on the toggle component of the switch.

Also disclosed is a method of promoting products and services comprising printing advertising material on glow in the dark caps that slip on the toggle component of a switch, and distributing the caps among a target audience. The caps can be distributed with installation instructions.

### DETAILED DESCRIPTION OF THE INVENTION

An embodiment of the present invention comprises a cap for a toggle light switch that slips on the toggle component of the switch, extending its reach, and facilitating its maneuverability. In another embodiment, the cap glows for increased visibility.

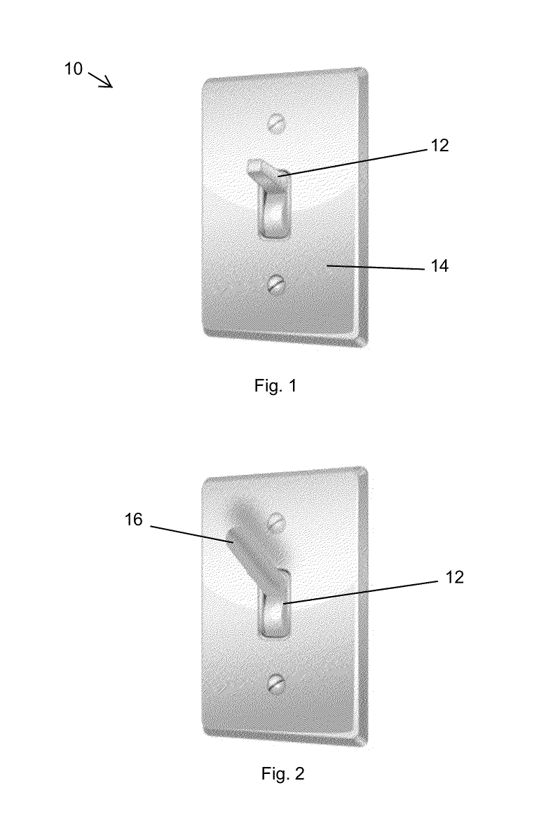

Referring to the accompanying drawings, and particularly to FIG. 1 according to one embodiment of the present invention, there is shown common toggle light switch 10 comprising toggle 12 and cover 14. This type of switch is commercially available with a standard toggle size, and the toggle does not glow in the dark. Although the toggle of these switches protrudes from the cover a few millimeters to aid the user in handling it, it is small enough that most users fumble to find it in the dark.

As illustrated in FIG. 2, one embodiment of the present invention comprises glow in the dark cap 16, which is disposed on toggle 12 to extend the reach of toggle 12, and increase its visibility in the dark. Cap 16 is sized to slip on toggle 12. Diverse cylindrical shapes can accommodate toggle 12, e.g. circular cylinders, rectangular cylinders, etc., and diverse shapes of the end of the cap may aid in extending the size of the cap for better maneuverability. Alternatively, embodiments of the invention may be taped on the toggle rather than slipped on. Another embodiment can comprise a doughnut shape that is slipped on the toggle.

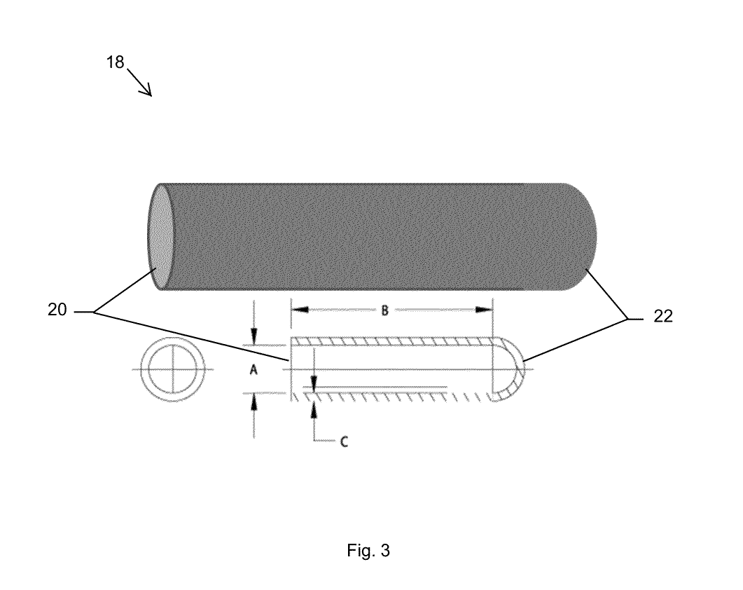

FIG. 3 illustrates one embodiment of cap 18 preferably comprising a circular cylindrical body B. The total length of cap 18 is preferably between approximately 1 inch and approximately 3 inches, however not limited thereto as lengths of over three inches are suitable. The inner diameter A of opening 20 is preferably between approximately 0.250 inches and approximately 0.281 inches, but can be made larger to accommodate a larger toggle. Thickness C is between approximately 0.045 inches and approximately 0.085 inches. End 22 is preferably round in shape.

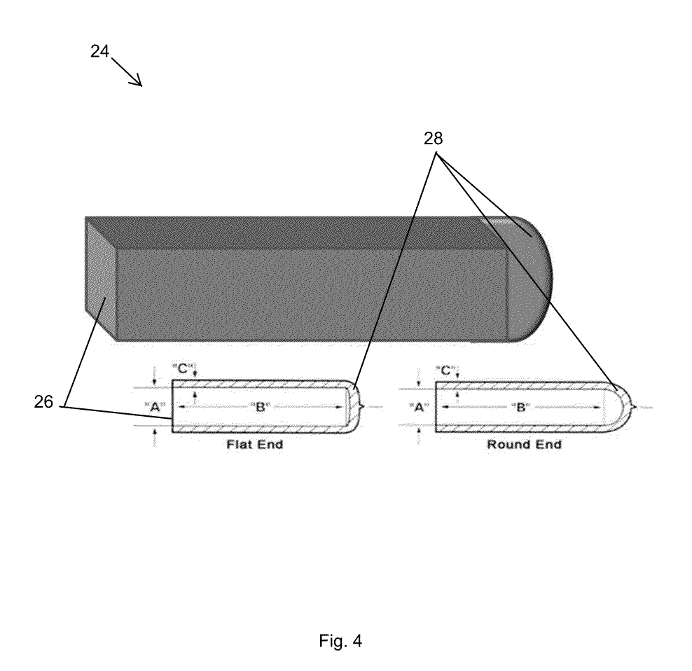

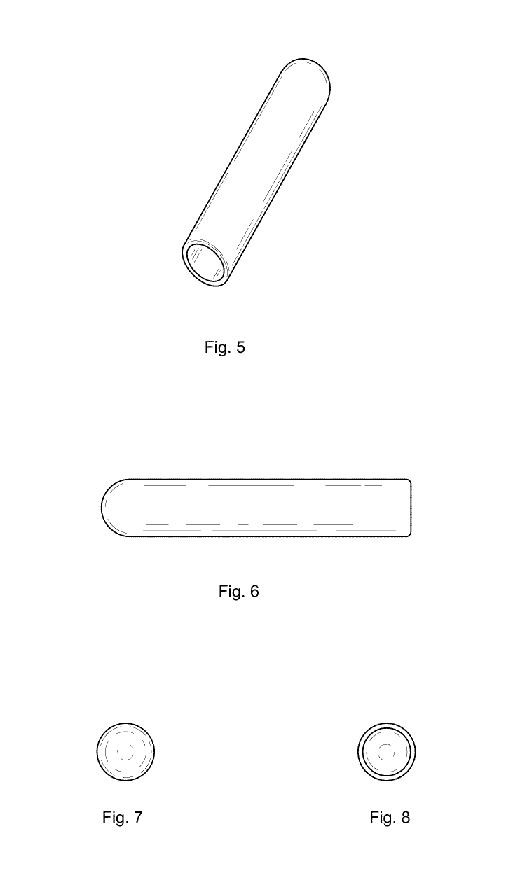

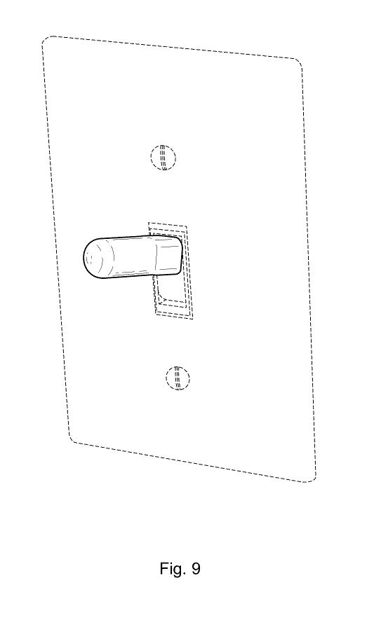

FIG. 4 illustrates another embodiment of the present invention. Cap 24 preferably comprises an angular body B, with a cylindrical end with a length that is preferably between approximately 1 inch and approximately 3 inches, however not limited thereto as lengths of over three inches are suitable. The inner diameter A of opening 26 is preferably between approximately 0.250 inches and approximately 0.281 inches, but can be made larger to accommodate a larger toggle. Thickness C is between approximately 0.045 inches and approximately 0.085 inches. End 28 is preferably round or flat in shape. However, other shapes can be suitable for extending the size of the cap to improve the maneuverability of the toggle.

Optionally in another embodiment, caps are manufactured from plastic commodity resins such as PVC, PE, PS, Nylon, Rubber, Silicon, or Vinyl (but not limited thereto) with aluminate photo luminescent pigment for the glow in the dark feature. The exterior surface of the caps of an embodiment of the present invention can be flat or, optionally, the surface can have a pattern to improve grip. Alternatively, images can be printed on the exterior surface of the cap for amusement or to get attention.

Phosphors are substances that radiate visible light when they are energized. There are thousands of chemical substances that behave like a phosphor. Calcium sulfide with strontium sulfide with bismuth as activator yields blue light with glow times up to 12 hours. Red color can be obtained from strontium sulfide. Mix of zinc sulfide and cadmium sulfide emit color depending on their ratio; increasing of the cadmium sulfide content shifts the output color towards longer wavelengths, e.g. reds. Its persistence ranges between 1-10 hours. Strontium aluminate activated by europium is a newer material with higher brightness and significantly longer glow persistence. Strontium aluminate produces green and aqua hues, where green gives the highest brightness and aqua the longest glow time. Strontium aluminate is about 10 times brighter and 10 times longer glowing than zinc sulfide. The excitation wavelengths for strontium aluminate range from 200 to 450 nm. The wavelength for its green formulation is 520 nm, its blue-green version emits at 505 nm, and the blue version emits at 490 nm. Colors with longer wavelengths can be obtained from the strontium aluminate as well, though with some loss of brightness. Some products that glow in the dark do not require to be energized by normal light to glow in the dark. A common example is the hands of some watches. To accomplish this effect, the phosphor is mixed with a radioactive element, and the radioactive emissions energize the phosphor continuously. Most glowing watches use tritium (which has a half-life of 12 years) or promethium, a man-made radioactive element with a half-life of around three years.

Phosphors can be directly added to plastic used to mold diverse products, or mixed with a binder for use as paints. A proven formulation representing a new generation of colored luminous technology involves the use of the benzimidazolone pigments with strontium mixes (either aluminates or silicate) and processed according to formulas and processes which provide the coloration. These pigments are available in a range of bright daytime colors—orange, pink, blue, purple, yellow green and brilliant whites that combined with the glow effect offer up to 24 hour visibility. These pigments are compatible with both polyolefins and engineering grade polymers. They are simple to use and do not require drying in most circumstances. Another advantage is that these pigments are UV stable and suitable for outdoor use.

An embodiment of the present invention comprises a method of extending the size and increasing the visibility of the toggle component of a switch. This method comprises providing a hollow cylindrical cap that glows in the dark, and slipping the cap on the toggle component of the switch.

An embodiment of the present invention also comprises a method of promoting products and services. This method comprises printing, or otherwise displaying, advertising material on glow in the dark caps that slip on the toggle component of a switch, and distributing the caps among a target audience. The caps can be distributed with installation instructions.

### EXAMPLE

Round cylindrical plastic caps were manufactured according to an embodiment of the present invention. The body of the caps measuring 1.5 inches in length, 0.250 inches in inner diameter, and 0.050 inches in thickness. High-end strontium aluminate photo luminescent benzimidazolone pigment was combined with resin, plasticizer, stabilizer, and colorant to provide up to eight hours of luminance. The caps had tear strength of 180-240 PPI, tensile strength of 1000-3000 PSI, 100-400% elongation, durometer of 68-78 shore A, good antistatic, and a glossy finish. Caps were manufactured in the following luminescent colors: aqua blue, yellow, lime green, orange, and pink.

Although embodiments of the present invention have been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A cap that slips on the toggle component of a switch comprising:
a hollow body with a first end and a second end;
said first end comprising an opening to slip said cap onto said toggle component;
said second end being closed; and
glow in the dark pigmentation in said body.

2. The cap of claim 1 wherein said body is an elongated cylinder.

3. The cap of claim 2 wherein said first end is sized to slip on said toggle.

4. The cap of claim 3 wherein said second end is round in shape.

5. The cap of claim 3 wherein said second end is flat in shape.

6. The cap of claim 1 further comprising a textured finish on said outer surface of said body.

7. The cap of claim 1 further comprising printed images on the outer surface of said body.

8. A method of extending the size and increasing the visibility of the toggle component of a switch comprising:
providing a hollow cylindrical cap that glows in the dark; and
slipping the cap on the toggle component of the switch.

9. A method of promoting products and services comprising:
printing advertising material on glow in the dark caps that slip on the toggle component of a switch; and
distributing the caps among a target audience.

10. The method of claim 9 wherein the caps are distributed with installation instructions.
